(19) United States
(12) Patent Application Publication
(10) Pub. No.: US 2024/0391280 A1
(43) Pub. Date: Nov. 28, 2024

(54) TOOL FOR USE WITH TIRE ASSEMBLIES

(71) Applicant: Edward Kelley Stagner, Orange, CA (US)

(72) Inventor: Edward Kelley Stagner, Orange, CA (US)

(21) Appl. No.: 18/200,565

(22) Filed: May 22, 2023

(51) Int. Cl. B60C 25/02

(52) U.S. Cl. CPC B60C 25/02

(57) ABSTRACT

A tire tool, and method of using, that can be used to manipulate tires by a user. The tire tool has a platform that can engage under a tire assembly, a front section, and a rear section. The tire tool can rotate between an engagement position and a pivoted position about a pivot. When in the pivoted position, a stop abuts the surface. The tire tool can be used by a user to lift a tire assembly off the ground, remove the tire assembly from an hub, and install the tire assembly on a hub.

### FIELD

The subject matter herein generally relates to a tool to assist in installing, removing, and transporting tires. While described in reference to large commercial tires used on intermodal chassis and semi-trucks, the invention is not limited to that use.

### BACKGROUND

In working with tires, it is understood that they are cumbersome and only get more so with heavier and larger tires. An operator must lift, move, rotate, and otherwise manipulate new and used tires during the installation, removal, and other actions. These tires can be dangerous and hazardous when the steel belts are exposed, and manual manipulation can cause serious injury.

### BRIEF DESCRIPTION OF THE DRAWINGS

Implementations of the present technology will now be described, by way of example only, with reference to the attached figures, wherein:

FIG. 1 shows an embodiment of the tire tool;

FIG. 2 shows an embodiment of a lower section of the tire tool;

FIG. 3 shows an embodiment of the lower section of the tire tool;

FIG. 4 shows an embodiment of the tire tool engaging a tire assembly that is mounted;

FIG. 5 shows an embodiment of the tire tool removing the tire assembly by rotating to the pivoted state;

FIG. 6 shows the detail of FIG. 4;

FIG. 7 shows the detail of FIG. 5;

FIG. 8 shows an embodiment of the tire tool transporting a tire assembly;

FIG. 9 shows an embodiment of the tire tool engaging a tire assembly on a surface; and

FIG. 10 shows an embodiment of the tire tool lifting a tire assembly off the surface.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale, and the proportions of certain parts may be exaggerated to better illustrate details and features. The description is not to be considered as limiting the scope of the embodiments described herein. It should be noted that references to “an” or “one” embodiment in this disclosure are not necessarily to the same embodiment, and such references mean at least one.

Several definitions that apply throughout this disclosure will now be presented.

The term “coupled” is defined as connected, whether integral with, directly attached, or indirectly attached through intervening components, and is not necessarily limited to physical connections. The connection can be such that the objects are permanently connected or releasably connected. The term “inside” indicates that at least a portion of a region is partially contained within a boundary formed by the object. The term “substantially” is defined to be essentially conforming to the particular dimension, shape, or other word that substantially modifies, such that the component need not be exact. For example, substantially cylindrical means that the object resembles a cylinder, but can have one or more deviations from a true cylinder.

The present disclosure is described in relation to a tire tool 100 for manipulating tires.

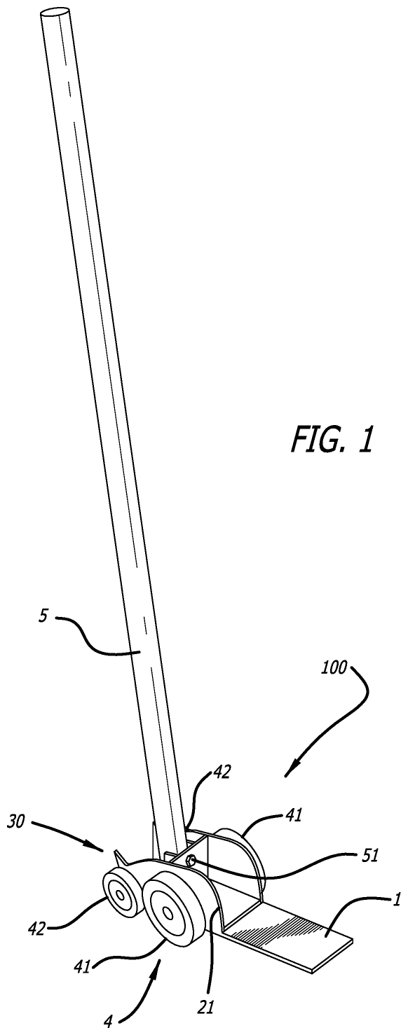

FIG. 1 illustrates an embodiment of the tire tool 100. In some embodiments, the tire tool 100 comprises one or more of the following: a platform 1, a front section 2, at least one pivot 41, a stop 42, a rear section 3, and a handle 5.

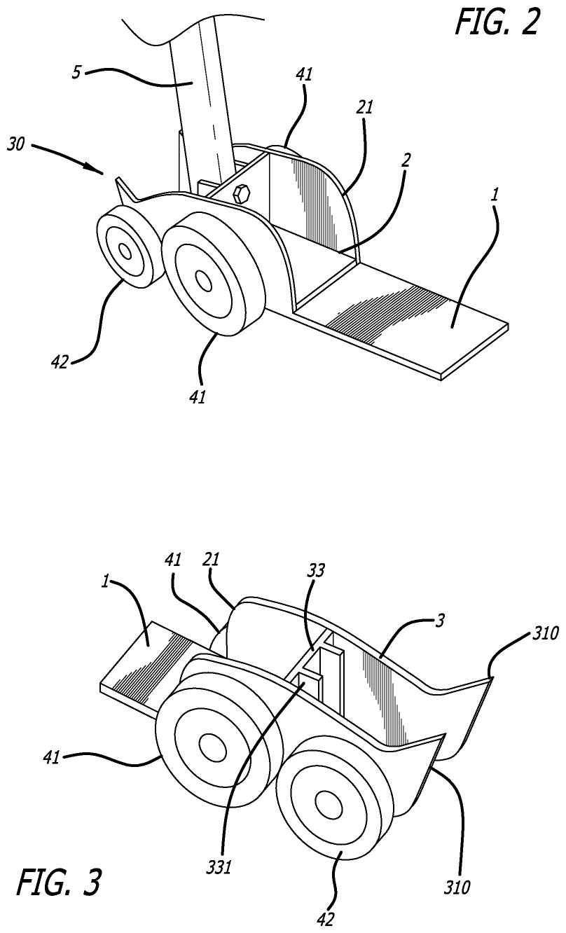

FIG. 2 illustrates an embodiment of the tire tool 100.

In some embodiments, the platform 1 comprises a planar extension extending from the front section 2. In some embodiments, the platform 1 is angled in relation to the front section 2. In some embodiments, the platform 1 is squared, rounded, some other shape, or a combination thereof. It is to be understood that the length of the platform 1 can be set as desired.

In some embodiments, the front section 2 comprises abutment section 21. The abutment section 21 is capable of abutting a tire assembly 8 when the tire assembly 8 is located on the platform 1. In some embodiments, the abutment section 21 prevents the tire assembly 8 from coming into contact with the pivot 41. In some embodiments, the abutment section 21 extends past the pivot 41. In some embodiments, the abutment section 21 is curved.

In some embodiments, the engagement section 31 extends away from rear section 3 towards the handle 5, when attached. In some embodiments, the engagement section 31 comprises one or more grippers 310. In some embodiments, there are two grippers 310, and in some embodiments, each gripper 310 defines a point. In some embodiments, the engagement section 31 extends past the stop 42.

In some embodiments, the tire tool 100 comprises a rear section 3. The rear section 3 comprises the engagement section 31. In some embodiments, the rear section 3 comprises 33 a handle connection section 33. In some embodiments, the handle 5 is secured to the handle connection section 33 by a securing member 51. In some embodiments, the handle 5 is integral with the rear section 3, the front section 2, between the rear section 3 and the front section 2, or a combination thereof.

In some embodiments, the one or more pivots 41 comprise two pivots 41. In some embodiments, one or more stops 42 comprise two stops 42. In some embodiments, one or more of the pivots 41 is a wheel, the one or more stops 42 is a wheel, or both. In some embodiments, the pivot 41 has a larger diameter than the stops 42, and/or the pivot 41 and the stops 42 are offset from each other. In some embodiments, the pivots 41 will be coupled together by an axle, the stops 42 will be coupled together by an axle, or a combination thereof.

FIG. 3 illustrates an embodiment of the tire tool 100. In some embodiments, the handle connection section 33 comprises ribs 331 that will at least extend partially along the width of the handle 5.

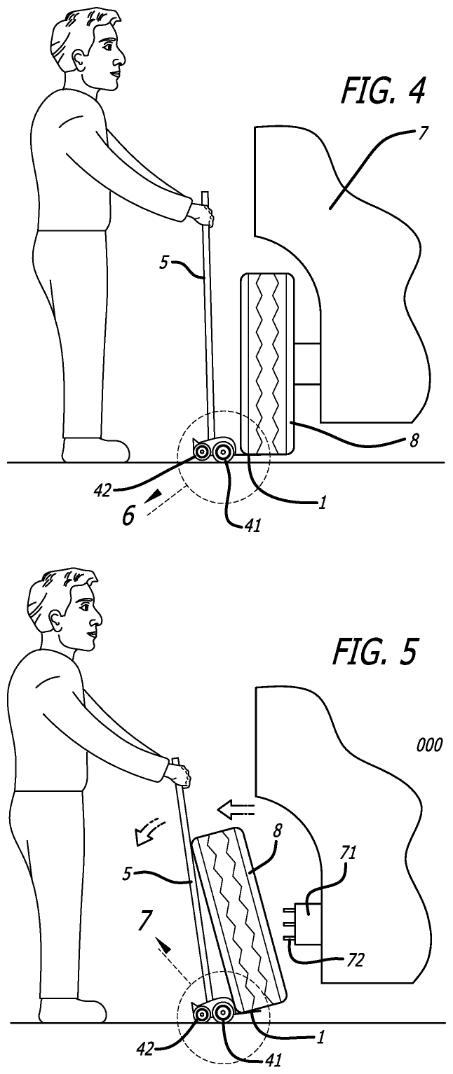

FIGS. 4-5 illustrate an embodiment of the method of using an embodiment tire tool 100. When a tire assembly 8 is located on the lugs 72, gravity causes the wheel to rest on the lugs 72. It is to be understood that in some applications, it will be spokes in the place of lugs 72, and when described and/or claimed herein, the term ‘lugs’ also includes, but is not limited to, spokes. In order to remove the tire assembly 8 from the lugs 72, a user must actually lift the tire assembly 8, but not too much, so that the wheel holes are off the top of the lugs 72 and not touching the bottom of the lugs 72. The tolerance is relatively small. Typically, without the tire tool 100, the user is trying to remove the tire assembly 8, and manually maintain the position within the tolerance, all the while handling a heavy combination of a tire assembly 8 and a wheel. Obviously, this becomes more difficult which larger tires assemblies 8.

As can be seen in FIGS. 4 and 5, the user brings the tire tool 100 to the tire assembly 8 such that the platform 1 is located beneath the tire assembly 8. The user then used the handle 5 to rotate the tire tool 100 and lift the tire assembly 8 off the lugs 72. Once the user pulls the handle 5, the tire tool 100 can rotate about the pivot 41 toward the pivoted state so that the stop 42 touches the ground. Once the tire assembly 8 is free from the lugs 72 and resting on the platform 1, the tire assembly 8 can lean against the handle 5. In some embodiments, once lifted the tire assembly 8 can be transported on the tire tool 100. In some embodiments, when the tire assembly 8 leans against the handle 5, it will help keep the tire tool 100 in the pivoted state.

It is to be understood that to place a tire assembly 8 on the lugs 72; the process can work in reverse. The user will transport the tire assembly 8 on the tire tool 100 in the pivoted state over to the vehicle. They will align the wheel holes with the lugs 72. This may entail rotating the lugs 72 or the tire assembly 8. The user will the rotate the tire tool 100 toward the engagement state such that the one or more lugs 72 are positioned inside the one or more wheel holes during the rotation.

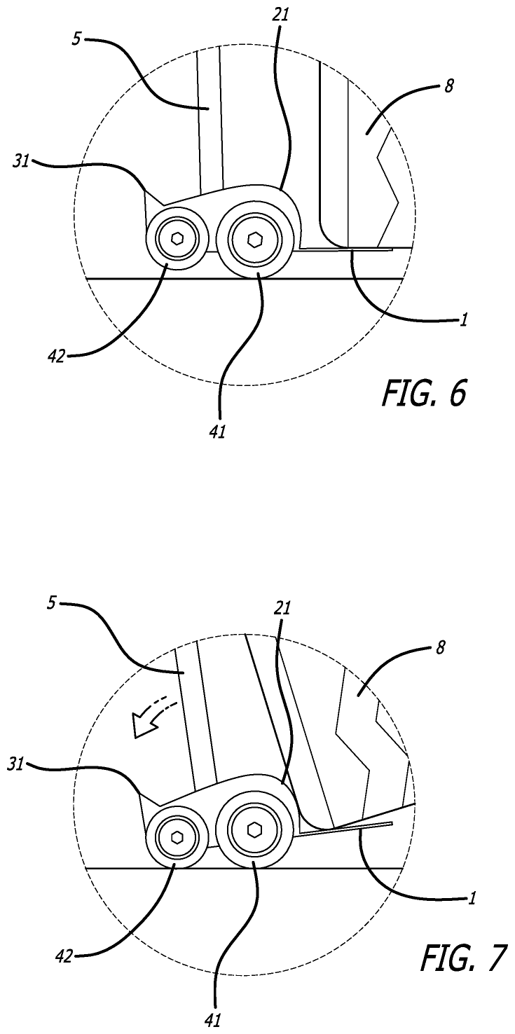

FIG. 6 illustrates an embodiment of the tire tool 100 in an engagement state wherein the platform 1 is substantially parallel to the surface. In some embodiments, the platform 1 abuts the surface when in the engagement state.

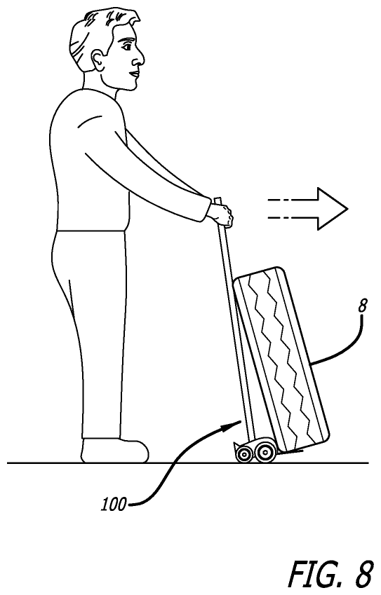

FIG. 7 illustrates an embodiment of the tire tool 100 in the pivoted state. In the pivoted state, both the pivot 41 and the stops 42 are on the surface. As can be seen, once the tire tool 100 is in the pivoted state, the platform 1 is at a greater angle, relative to the surface, than the platform 1 in the engagement state. It is the angling of the platform 1 that raises the tire assembly 8 when the tire tool 100 moves from the engagement state toward the pivoted state.

FIG. 8 illustrates an embodiment of the tire tool 100 in the pivoted state and moving the tire assembly 8.

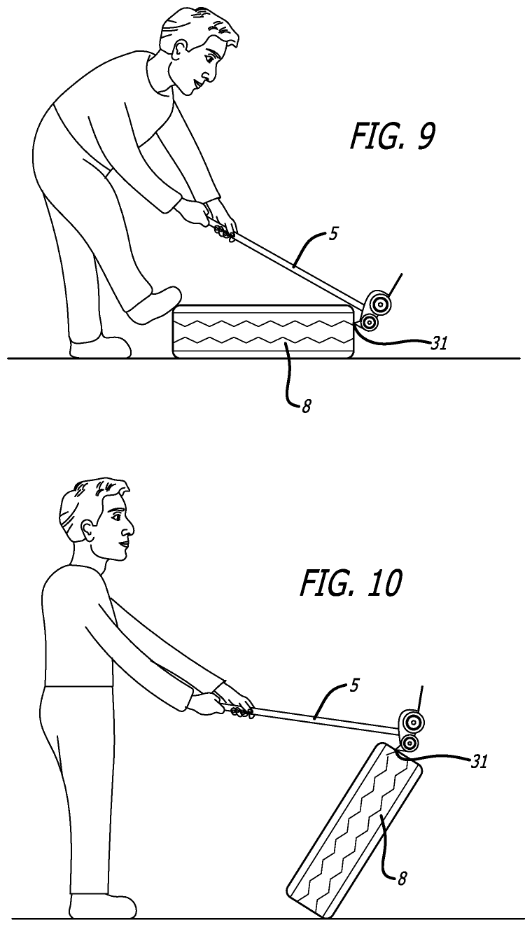

FIGS. 9 and 10 show an embodiment a method using an embodiment of the tire tool 100 to lift a tire assembly 8 off the surface. As can be seen, a user will place the tire tool 100 so that the engagement section 31 engages the tire assembly 8. In some embodiments, the engagement section 31 will engage the tread of the tire assembly 8. The user can pull handle 5 so that the tire assembly 8 is substantially vertical and not lying on the surface. Once vertical, the user can wedge the platform 1 underneath the tire assembly 8 and then rotate the tire tool 100 to the pivoted state.

The methods described below can be carried out using the configurations illustrated in FIGS. 1-10, for example, and various elements of these figures are referenced in explaining the methods. The methods comprise one or more processes, methods or subroutines, carried out in the example methods. Furthermore, the order of steps as described is illustrative only, and the order of the steps can change according to the present disclosure. Additional steps can be added or fewer steps may be utilized, without departing from this disclosure.

A method for using the tire tool 100 comprises one or more of the following:
A) placing the platform 1 under the tire assembly 8;
B) rotating the tire tool 100 to the engagement state;
C) place a lug in a wheel hole; and
D) secure the tire assembly 8 to a hub 71.

Some embodiments of the method further comprise moving the tire tool 100 to the pivoted state. Some embodiments comprise moving the tire tool 100 with a tire assembly 8 on the platform 1 in the pivoted state. Some embodiments of the method comprise moving the tire tool 100 from the pivoted state to and/or toward the engagement section 31 state.

Some embodiments comprise engaging the tire assembly 8 with the engagement section 31. In some embodiments, engaging the tire assembly 8 with the engagement section 31 comprises the user standing on one side of the tire assembly 8 and engaging the tire assembly 8 with the engagement section 31 on another side. Some embodiments comprise pulling the handle 5 to rotate the tire assembly 8 toward a vertical position. In some embodiments, pulling the handle 5 comprises placing a foot on the tire assembly 8. In some embodiments, the user will place a foot on the tire tool 100 or pinning it between the foot and the tire assembly 8 to keep it from rolling.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure up to, and including, the full extent established by the broad general meaning of the terms used in the claims.

It should also be noted that elements of embodiments may be described in reference to the description of a particular embodiment; however, it is disclosed that elements of disclosed embodiments can be switched with corresponding elements of embodiments with the same name and/or number of other disclosed embodiments.

Depending on the embodiment, certain steps of the methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. An apparatus comprising:
a tire tool, wherein the tire tool comprises:
a platform;
a front section, wherein the platform is coupled to the front section;
a rear section coupled to the front section;
at least one pivot coupled to the front section;
at least one stop coupled to the rear section;
wherein the tire tool is configured to move between an engagement state and a pivoted state when resting on surface; in the engagement state, the at least one pivot abuts the surface and the at least one stop is located above the surface; in the pivoted state, the at least one pivot and the at least one stop abuts the surface.

2. The apparatus of claim 1, wherein the at least one pivot comprises two pivots; the at least one stop comprises two stops; and the two stops are offset from the two pivots.

3. The apparatus of claim 1, wherein the at least one pivot are wheels, the at least one stop are wheels, or both the at least one pivot and the at least on stop are wheels.

4. The apparatus of claim 3, wherein the at least one pivot comprises two pivots; the at least one stop comprises two stops; and a center of the two stops are offset from the two pivots, the two stops are smaller than the two pivots, or a combination thereof.

5. The apparatus of claim 1, wherein the rear section further comprises an engagement section.

6. The apparatus of claim 5, wherein the engagement section defines one or more grippers.

7. The apparatus of claim 1, wherein the tire tool further comprises a handle.

8. The apparatus of claim 1, wherein the front section comprises an abutment section.

9. The apparatus of claim 8, wherein the abutment section extends past each pivot.

10. A method, the method comprises:
A) providing a tire tool according to claim 1 and a tire assembly;
B) placing the platform underneath the tire assembly that is mounted on one or more lugs;
C) lifting the tire assembly with the tire tool; and
D) removing the tire assembly from the one or more lugs.

11. The method of claim 10, wherein lifting the tire assembly with the tire tool comprises moving the tire tool toward the pivoted state.

12. The method of claim 10, wherein the tire tool further comprises a handle; and the removing the tire assembly comprises rotating the tire assembly so that it abuts the handle.

13. The method of claim 10, further comprising F) transporting the tire assembly on the tire tool.

14. The method of claim 10, further comprising G) rotating the tire tool about the at least one pivot toward the pivoted state, rotating the tire tool about the at least one pivot toward the engagement state, or a combination thereof.

15. A method, the method comprises:
A) providing a tire tool according to claim 1 and a tire assembly;
B) engaging the tire assembly located on the surface with the tire tool; and
C) lifting the tire assembly with the tire tool.

16. The method of claim 15, wherein the engaging the tire assembly located on the surface comprises rotating the tire tool to the engagement state; and positioning the platform under the tire assembly.

17. The method of claim 16, wherein the lifting the tire assembly comprises rotating the tire tool from the engagement state toward the pivoted state.

18. The method of claim 15, wherein the tire tool further comprises an engagement section; and the engaging the tire assembly located on the surface comprises extending the tire tool across the tire assembly and engaging the tire assembly with the engagement section.

19. The method of claim 18, wherein the lifting the tire assembly with the tire tool comprises rotating the tire assembly from a substantially horizontal position toward a substantially vertical position.

20. The method of claim 15, further comprising D) rotating the tire tool about the at least one pivot toward the pivoted state, rotating the tire tool about the at least one pivot toward the engagement state, or a combination thereof.
